(19) United States
(12) Patent Application Publication
(10) Pub. No.: US 2017/0100985 A1
(43) Pub. Date: Apr. 13, 2017

(54) REFRIGERATION EFFICIENCY MONITORING SYSTEM

(71) Applicant: Ritchie Engineering Company, Inc., Bloomington, MN (US)

(72) Inventors: KARL JOHNSON, St. Michael, MN (US); JAHN STOPPERAN, Lakeville, MN (US)

(21) Appl. No.: 15/288,880

(22) Filed: Oct. 7, 2016

Related U.S. Application Data
(60) Provisional application No. 62/239,656, filed on Oct. 9, 2015.

(51) Int. Cl. B60H 1/00; B60H 1/32

(52) U.S. Cl. CPC B60H 1/00978; B60H 1/3205; B60H 2001/3251; B60H 2001/3252; B60H 2001/3255; B60H 2001/3245; B60H 2001/3261

(57) ABSTRACT

A refrigeration efficiency monitoring system detects degradation of a refrigeration system by monitoring a deviation from a normal operating status of the refrigeration system at an early stage of such degradation. The monitoring system detects and calculates a plurality of system parameters associated with the refrigeration system. The monitoring system then determines a decrease in efficiency of the refrigeration system based on comparison between the system parameters and reference values representative of the normal operating status, and generate a service recommendation based on the determination.

### CROSS-REFERENCE TO RELATED APPLICATIONS

The present application claims priority from U.S. Provisional Patent Application No. 62/239,656, filed Oct. 9, 2015, the disclosure of which is hereby incorporated by reference in its entirety.

### BACKGROUND

Refrigeration systems control air conditions, such as temperature and humidity, within spaces or on surfaces in various applications, such as freezers, refrigerators, vehicle spaces, beverage or food containers, office environments, and other consumer and business areas. Refrigeration systems typically provide air conditioning by controlling a compressor in the systems to adjust compression level of a refrigerant. Some refrigeration systems include a temperature sensing device for monitoring a resultant cooled air or fluid, and operates to adjust the compression level of the refrigerant based on a desired temperature setting and the monitored temperature. For example, a thermostat causes a compressor of an air conditioning system to operate when the temperature of air in a room is lower than a set temperature of a sensor in the thermostat, or to stop operating when the air temperature reaches the set temperature.

Some examples of refrigeration systems provide a notification when a resulting cooling effect has declined to certain level. For example, when the resulting temperature indicator has reached the level, an alert is issued in one or more forms (e.g., audible or visual) so that a service technician is summoned to make necessary repairs to the system to prevent continued declined in the resulting temperature and return the system to its normal cooling condition.

Over time, refrigeration systems begin to lose efficiency and effectiveness for various reasons. One example is a leak in a refrigeration system that causes refrigerant to escape. In another example, refrigerant's cooling properties can be altered due to contamination of the refrigerant. In other examples, air can be introduced into the refrigeration system and deteriorate the operation of refrigerant. In yet other examples, the refrigeration system can be plugged, which prevents normal flow of refrigerant. These factors can result in a change in the pressurization process and decrease the efficiency of the systems.

Some refrigeration systems are designed to automatically correct the change in the pressurization process to produce a consistent cooling result, when the systems lose efficiency in refrigeration operation. For example, when a refrigeration system becomes less efficient and effective, a temperature sensing device in the system detects the end temperature, and a compressor is controlled to reach or maintain the end temperature to be the set temperature. In this operation, the compressor can be run longer or harder or both and, therefore, the refrigeration system loses efficiency. As a result, the desired end temperature can still be attained. However, it is not easily recognizable that the refrigeration system has lost efficiency and worked harder or longer to overcome deficiencies.

### SUMMARY

In general terms, this disclosure is directed to a refrigeration efficiency monitoring system. In one possible configuration and by non-limiting example, the system detects various system parameters of a refrigeration system and determines a deviation from a normal operating status of the refrigeration system at an early stage based on the system parameters. Various aspects are described in this disclosure, which include, but are not limited to, the following aspects.

One aspect is a method of maintaining a refrigeration system that is configured to control a temperature within a cabin. The method includes arranging a first pressure sensor at a low pressure side of the refrigeration system; arranging a second pressure sensor at a high pressure side of the refrigeration system; running the refrigeration system for a preset period of time; obtaining a low side pressure at the low pressure side using the first pressure sensor; obtaining a high side pressure at the high pressure side using the second pressure sensor; obtaining a cabin air temperature using at least one temperature sensor; obtaining ambient temperature around the refrigeration system; determining a status of the refrigeration system by monitoring a deviation of at least one of the low side pressure, the high side pressure, the cabin air temperature, and the ambient temperature from at least one reference value, the at least one reference value representative of a normal operational status of the refrigeration system; and generating a service recommendation based on the status of the refrigeration system.

Another aspect is a system for monitoring a refrigeration system for controlling a temperature within a cabin. The refrigeration system includes a low pressure conduit defining a low pressure side of the refrigeration system, and a high pressure conduit defining a high pressure side of the refrigeration system. The monitoring system includes at least one sensing device and a monitoring device. The at least one sensing device is configured to detect a plurality of characteristics of the refrigeration system. The plurality of characteristics includes at least one of ambient temperature, cabin air temperature, high side pressure, and low side pressure. The monitoring device is connected to the at least one sensing device. The monitoring device is configured to receive a plurality of measurements representative of the plurality of characteristics from the at least one sensing device, determine a deviation of at least one of the plurality of measurements from at least one reference value, and output a status of the refrigeration system based on the deviation. The at least one reference value is representative of a normal operational status of the refrigeration system.

Yet another aspect is a method of maintaining a refrigeration system for controlling a temperature within a cabin. The method includes arranging a first pressure sensor at a low pressure side of the refrigeration system; arranging a second pressure sensor at a high pressure side of the refrigeration system; receiving relative humidity; receiving ambient temperature around the refrigeration system; obtaining a first low side pressure at the low pressure side and a first high side pressure at the high pressure side using the at least one pressure sensor; determining a soak pressure based on the low pressure and the high pressure; if the soak pressure is greater than a first predetermine value, outputting a notification that recommends a service of the refrigeration system; if the soak pressure is not greater than the first predetermined value, running the refrigeration system for a preset period of time; obtaining a minimum low side pressure at the low pressure side using the first pressure sensor; obtaining a maximum high side pressure at the high pressure side using the second pressure sensor; obtaining a cabin air temperature using at least one temperature sensor; obtaining an air vent temperature using the at least one temperature sensor; and determining a difference between the maximum high side pressure and the minimum low side pressure; determining that the difference between the maximum high side pressure and the minimum low side pressure is greater than a second predetermined value; if the difference between the maximum high pressure and the minimum low pressure is greater than a second predetermined value, calculating a high side temperature difference, the high side temperature difference being a temperature corresponding to the maximum high side pressure less the ambient temperature; calculating a low side temperature difference, the low side temperature difference being the cabin air temperature less a temperature corresponding to the minimum low side pressure; calculating a first air temperature difference, the first air temperature difference being the ambient temperature less the air vent temperature; calculating a second air temperature difference, the second air temperature difference being the cabin air temperature less the air vent temperature; monitoring a deviation of at least one of the high side temperature difference, the low side temperature difference, the first air temperature difference, and the second air temperature difference from at least one reference value, the at least one reference value representative of a normal operational status of the refrigeration system; and determining a status of the refrigeration system based on the deviation.

The above features and advantages and other features and advantages of the present teachings are readily apparent from the following detailed description for carrying out the present teachings when taken in connection with the accompanying drawings.

### BRIEF DESCRIPTION OF THE DRAWINGS

FIG. 1 schematically illustrates a system in which a refrigeration system is controlled by a refrigeration management system in accordance with an exemplary embodiment of the present disclosure.

FIG. 2 is a block diagram of an example efficiency monitoring system of FIG. 1.

FIG. 3 illustrates an exemplary architecture of a computing device that can be used to implement aspects of the present disclosure.

FIG. 4 illustrates an exemplary operational status of the refrigeration system.

FIG. 5 is a flowchart illustrating a method of operating the refrigeration management system in accordance with an exemplary embodiment of the present disclosure.

FIG. 6 is a flowchart illustrating a method of operating the refrigeration management system in accordance with another exemplary embodiment of the present disclosure.

FIG. 7 is a flowchart illustrating a method of operating the refrigeration management system in accordance with yet another exemplary embodiment of the present disclosure.

FIG. 8 is an exemplary table for data points of pressure and temperature of a refrigerant in a normal operating condition.

FIG. 9 is an exemplary table for data points of pressure and temperature of another refrigerant in a normal operating condition.

FIG. 10 illustrates an example report generated by the refrigeration management system as a result of refrigeration efficiency monitoring.

### DETAILED DESCRIPTION

Various embodiments will be described in detail with reference to the drawings, wherein like reference numerals represent like parts and assemblies throughout the several views.

In general, a refrigeration management system according to an exemplary embodiment of the present disclosure detects a change or deviation from a normal operating condition of a refrigeration system early at a stage in which the efficiency of the refrigeration system decreases. This can avoid an impact on a resultant air conditioning level, or avoid over-taxing of a refrigeration system designed to compensate for loss in efficiency. In particular, the refrigeration management system of the present disclosure detects a decrease in refrigeration system efficiency before that decrease is noticeable to a user in the form of decreased cooling capability, and provides a notification that refrigeration system under test has changed the operating conditions thereof. The refrigeration management system can provide such a notification before a user has noticed it, before an alarm is triggered based on a decreasing end temperature measured by a temperature sensor, or before a compressor in the refrigeration system increases the workload thereof to compensate the decreasing efficiency.

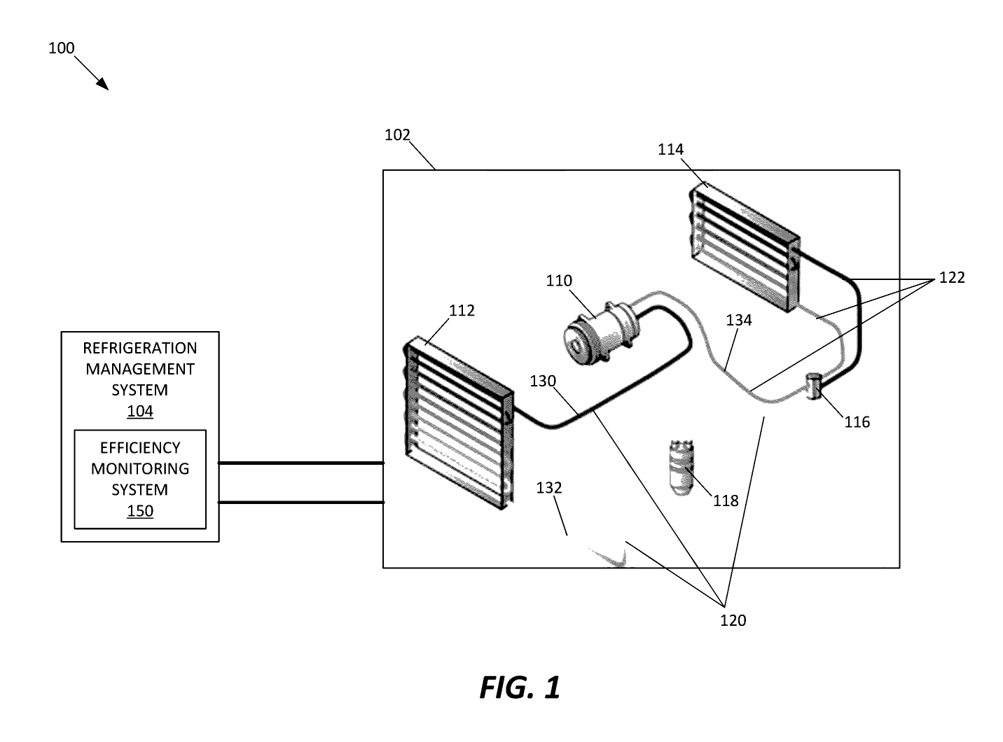

Referring to FIG. 1, a system 100 includes a refrigeration system 102 and a refrigeration management system 104.

The refrigeration system 102, which is also referred to herein as an air conditioning system, operates to control the condition of air in a space, such as a compartment or cabin. The refrigeration system 102 is controlled by a set of operator controls, such as an ON/OFF switch, a temperature control, and a blower of fan speed control. The refrigeration system includes a control unit that generates control signals to regulate the air temperature in the space based on the settings of operator controls.

In some examples, the refrigeration system 102 has a refrigerant circuit that includes a compressor 110, a condenser 112, an evaporator 114, an expansion valve 116, and a receiver dryer 118. A refrigerant is circulated through the refrigerant circuit to cool the space. A refrigerant is of various types. Some examples of refrigerants include Freon, R134a, and R1234yf. Since these components 110, 112, 114, 116, and 118 are well known in the air conditioning field, the precise construction of the components 110, 112, 114, 116, and 118 are not described or illustrated in the detail herein.

The refrigerant circuit further includes a high pressure tubing 120 and a low pressure tubing 122. The high pressure tubing 120 and the low pressure tubing 122 operatively connect the various components of the refrigeration system 102 to one another. The high pressure tubing 120 is provided with the expansion valve 116 adjacent an inlet of the evaporator 114 for regulating refrigerant flow from the condenser 112 to the evaporator 114.

The condenser 112 operates to condense the refrigerant, and the condensed refrigerant is delivered through the expansion valve 116, which expands the liquid-phase or saturated liquid-vapor-phase refrigerant to a cold, low-pressure liquid-vapor phase refrigerant having a higher vapor content. The cold liquid-vapor-phase refrigerant (having a higher vapor content than the refrigerant exiting the condenser) then runs through the evaporator 114, which is typically a coil that absorbs heat from and cools the air delivered to the space or cabin. As high pressure refrigerant passes through the expansion valve 116, the refrigerant expands and drops in temperature entering into a low pressure state in the evaporator 114. In the evaporator 114, the low pressure (low temperature) refrigerant absorbs heat from the space to cool the space. Thereafter, the low pressure tubing 122 conveys low pressure refrigerant from the evaporator 114 to the compressor 110.

The high pressure tubing 120 operatively connects the various high pressure sides of the components of the refrigeration system 102. Specifically, the high pressure tubing 120 conveys compressed (high pressure) refrigerant leaving the compressor 110 to the condenser 112 and then from the condenser 112 to the expansion valve 116 that is proximate to the evaporator 114. The high pressure tubing 120 includes a compressor outlet section 130 and a condenser outlet section 132. The compressor outlet section 130 is connected between the compressor 110 and the condenser 112. The compression action of the compressor 110 heats the refrigerant, resulting in a hot, high-pressure vapor-phase refrigerant. Thus, the compressor outlet section 130 is configured to convey compressed or high pressure refrigerant outputted from the compressor 110 to the condenser 112 for dissipation of heat. In the condenser 112, this hot vapor-phase refrigerant flows through the coils of the condenser 112 to dissipate heat. The condenser outlet section 132 is connected to the condenser 112 and the expansion valve 116, which is proximate the evaporator 114. The condenser outlet section 132 is configured to convey high pressure refrigerant from the condenser 112 to the expansion valve 116.

The low pressure tubing 122 operatively connects the various low pressure sides of the components of the refrigeration system 102. Specifically, the low pressure tubing 122 conveys gaseous (low pressure) refrigerant leaving the evaporator 114 to the compressor 110. The low pressure tubing 122 includes a evaporator outlet section 134 connected to an outlet of the evaporator 114 and configured to convey low pressure refrigerant from the evaporator 114 to the compressor 110.

In some embodiments, the refrigeration system 102 can further include the receiver dryer 118 that is arranged upstream of the expansion valve 116 and works as a storage device for liquid refrigerant suitable for the expansion valve 116. The receiver dryer 118 operates to separate gas and store liquid refrigerant. In other examples, the receiver dryer 118 operates to trap water vapor and filter out dirt.

It should be understood that the components 110, 112, 114, 116, and 118, the high pressure tubing 120, and the low pressure tubing 122 can have any of a variety of configurations and connections. The descriptions above of the various connections are merely one example of the configurations of the components 110, 112, 114, 116, and 118, the high pressure tubing 120, and the low pressure tubing 122.

Referring still to FIG. 1, the refrigeration management system 104 operates to manage and maintain the refrigeration system 102. The refrigeration management system 104 is connected to at least one of the refrigeration systems 102 and performs various operations for managing the associated refrigeration system 102. The refrigeration management system 104 can be hydraulically/pneumatically connected to a refrigeration system via one or more hoses. In some embodiments, the refrigeration management system 104 operates to recover, recycle, and/or recharge a refrigerant of the refrigeration system 102.

In some embodiments, the refrigeration management system 104 includes an efficiency monitoring system 150. As described herein in more detail, the efficiency monitoring system 150 can be implemented using (at least in part) a controller or computing device, and is programmed to detect a change or deviation from a normal operating condition of the refrigeration system 102 early at a stage in which the efficiency of the refrigeration system 102 decreases. In particular, the efficiency monitoring system 150 of the refrigeration management system 104 detects degradation of the refrigeration system early on and provides a notification of such decreased system efficiency before the change in efficiency is noticeable or measurable by temperature sensors. In some embodiments, the efficiency monitoring system 150 operates to detect the efficiency change before the compressor and/or other components of the refrigeration system 102 increase the workload thereof to compensate the decreasing efficiency.

In this document, the refrigeration management system 104 including the efficiency monitoring system 150 is primarily illustrated to manage a refrigeration system 102 that includes a vehicle air conditioning system. In automotive applications such refrigerants can include R134a, which has generally known environmental concerns, as well as HFO-1234yf, which is a less environmentally problematic replacement for R134a. However, the refrigeration management system 104 can also be configured and used for other types of refrigeration systems 102. In such other types of refrigeration systems, other refrigerants may be used.

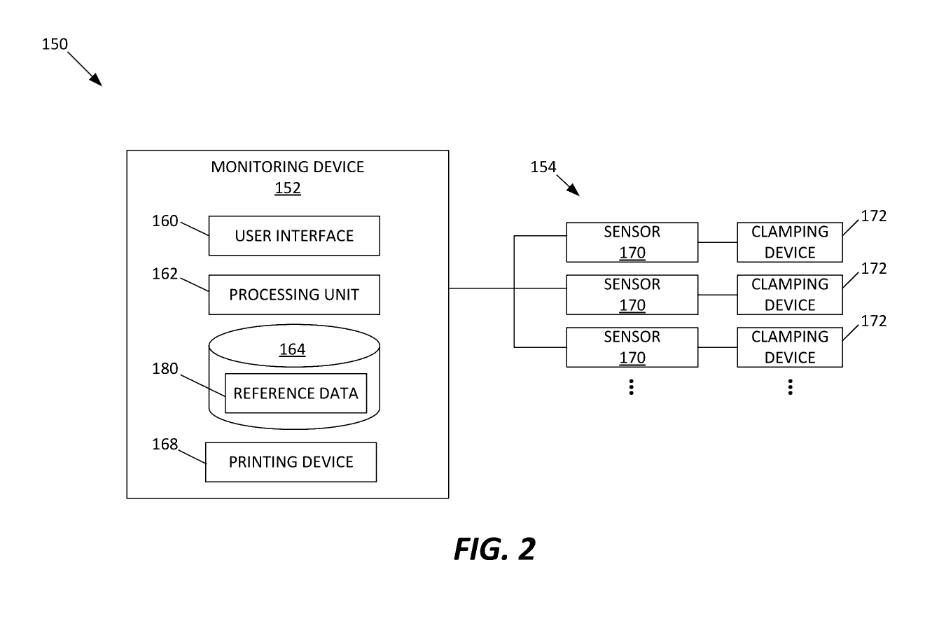

FIG. 2 is a block diagram of an example of the efficiency monitoring system 150 of FIG. 1. In some embodiments, the efficiency monitoring system 150 includes a monitoring device 152 and a sensing device 154. The monitoring device 152 includes a user interface 160, a processing unit 162, a storage unit 164, and a printing device 168. The sensing device 154 includes one or more sensor units 170 and

The user interface 160 operates to receive a user input of configuring and operating the monitoring device 152. The user interface 160 is also configured to display various pieces of information, such as measurements through the sensor device 154, evaluation results of the associated refrigeration system 102, and operational status of the monitoring device 152.

The processing unit 162 operates to control components in the monitoring device 152. The processing unit 162 also receives data signals from components (such as the user interface 160, and the storage unit 164, and the printing device 168) in the monitoring device 152, to perform various processes.

The storage unit 164 is used to store data, such as the reference data 180. As described below, the reference data 180 include reference values that are used to determine degradation of the refrigeration system 102.

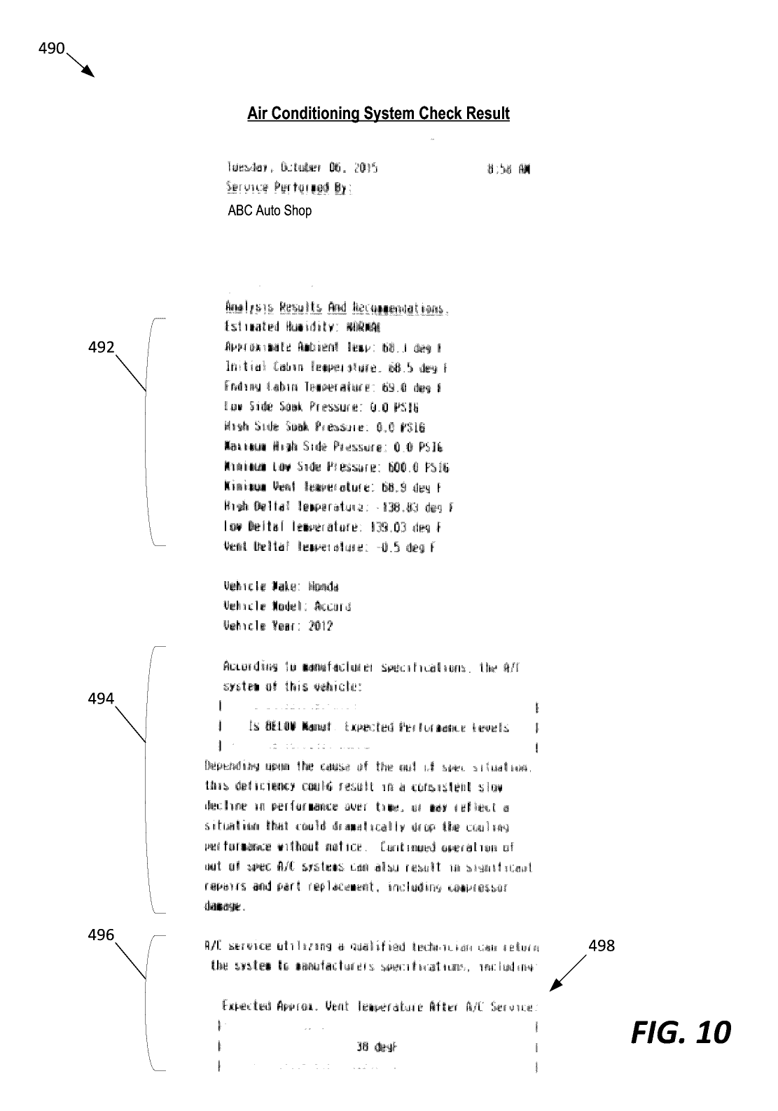

The printing device 168 operates to document efficiency monitoring results and/or other information in such a fashion to enable easy disclosure to a user. An example of such document is illustrated in FIG. 10 and described below in more detail.

The sensor units 170 operate to measure one or more parameters associated with the refrigeration system 102. In automotive applications, the sensor units 170 can be mounted to various locations in a vehicle. In some examples, the sensor units 170 are wired to the monitoring device 152. In other examples, the sensor units 170 are wirelessly connected to the monitoring device 152. In yet other examples, some of the sensor units 170 are wired to the monitoring device 152, and the other sensor units 170 wirelessly communicate with the monitoring device 152.

As described herein, the sensor units 170 are used to obtain a plurality of data points adapted for identifying whether the refrigeration system 102 has experienced a shift from a normal operating state.

Some of the sensor units 170 can be configured as pressure transducers for sensing pressures at various locations in the refrigeration system 102. For example, at least one of the sensor unit 170 is a high side pressure transducer that is mounted to a high pressure side (such as the high pressure tubing 120) of the refrigeration system 102, and at least one of the sensor unit 170 is a low side pressure transducer that is mounted to a low pressure side (such as the low pressure tubing 122) of the refrigeration system 102.

Further, some of the sensor units 170 are configured as temperature sensors for measuring temperatures at various locations in the refrigeration system 102. For example, at least one of the sensor units 170 is a temperature probe configured to detect the temperature of refrigerant lines, and at least one of the sensor units 170 is a temperature probe configured to measure air temperature.

In addition, some of the sensor units 170 are configured to identify the dew point. Further, some of the sensor units 170 are configured to detect humidity level.

In some embodiments, a single sensor unit 170 is utilized to measure a plurality of parameters. For example, a single sensor unit 170 configured as a temperature probe is used to detect the temperature of ambient air around the refrigeration system 102 in, for example, a vehicle, or around an engine of the vehicle, the temperature within the cabin of the vehicle, and the temperature of the air exiting the vent in the cabin. Such a single sensor unit is movable to be mounted to different locations for different measurements. By way of example, a single temperature sensor is arranged at the cabin to measure a cabin air temperature, moved to or adjacent an air vent in the cabin to measure an air vent temperature, and moved outside the cabin to measure an ambient temperature. In such configuration, the monitoring device 152 can use timing sequences that align with such a single sensor unit being in different physical positions during measuring process.

The clamping devices 172 are configured to mount the sensor units 170 to different locations in or around the refrigeration system 102. In some embodiments, the clamping devices 172 are configured to couple or clip the sensor units 170 to different portions of the structure of, e.g., a vehicle in which the refrigeration system 102 is implemented. Various configurations of the clamping devices 172 are possible.

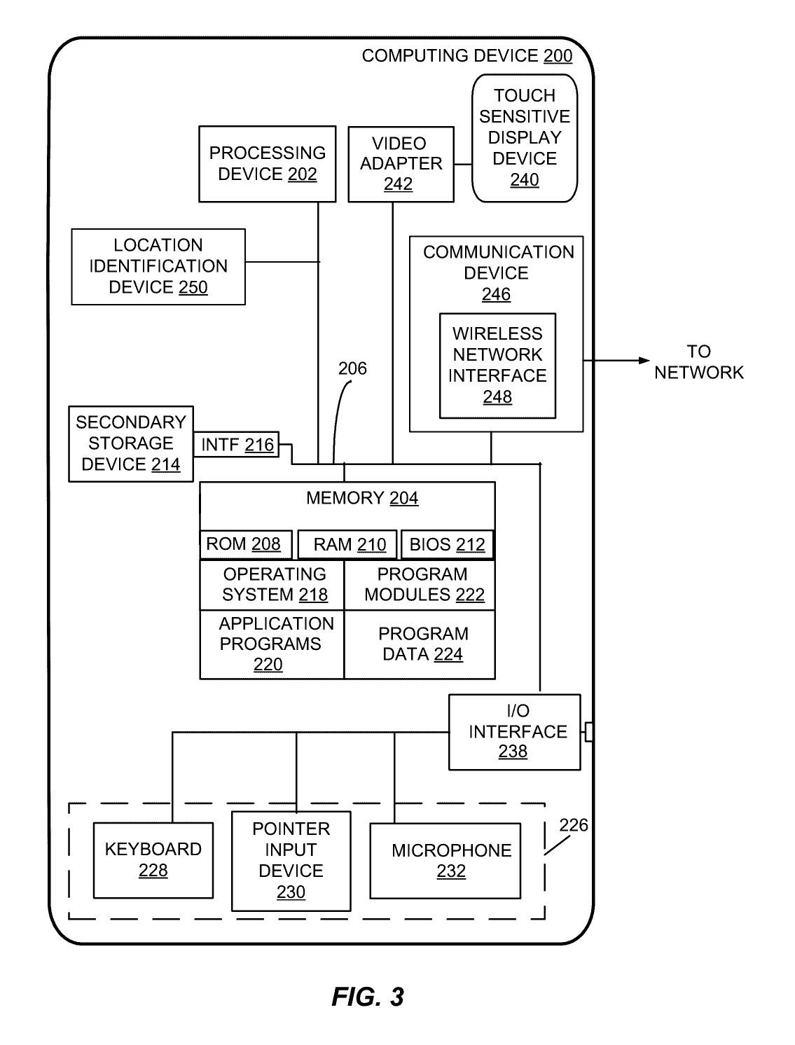

Referring to FIG. 3, an exemplary architecture of a computing device is illustrated, which can be used to implement aspects of the present disclosure, including the refrigeration management system 104, the efficiency monitoring system 150 thereof, or the monitoring device 152 thereof. Such a computing device is designated herein as reference numeral 200. The computing device 200 is used to execute the operating system, application programs, and software modules (including the software engines) described herein.

The computing device 200 includes, in some embodiments, at least one processing device 202, such as a central processing unit (CPU). A variety of processing devices are available from a variety of manufacturers, for example, Intel or Advanced Micro Devices. In this example, the computing device 200 also includes a system memory 204, and a system bus 206 that couples various system components including the system memory 204 to the processing device 202. The system bus 206 is one of any number of types of bus structures including a memory bus, or memory controller; a peripheral bus; and a local bus using any of a variety of bus architectures.

Examples of computing devices suitable for the computing device 200 include a desktop computer, a laptop computer, a tablet computer, a mobile device (such as a smart phone, an iPod® mobile digital device, or other mobile devices), or other devices configured to process digital instructions.

The system memory 204 includes read only memory 208 and random access memory 210. A basic input/output system 212 containing the basic routines that act to transfer information within computing device 200, such as during start up, is typically stored in the read only memory 208.

The computing device 200 also includes a secondary storage device 214 in some embodiments, such as a hard disk drive, for storing digital data. The secondary storage device 214 is connected to the system bus 206 by a secondary storage interface 216. The secondary storage devices and their associated computer readable media provide nonvolatile storage of computer readable instructions (including application programs and program modules), data structures, and other data for the computing device 200.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media.

A number of program modules can be stored in secondary storage device 214 or memory 204, including an operating system 218, one or more application programs 220, other program modules 222, and program data 224.

In some embodiments, computing device 200 includes input devices to enable a user to provide inputs to the computing device 200. Examples of input devices 226 include a keyboard 228, pointer input device 230, microphone 232, and touch sensitive display 240. Other embodiments include other input devices 226. The input devices are often connected to the processing device 202 through an input/output interface 238 that is coupled to the system bus 206. These input devices 226 can be connected by any number of input/output interfaces, such as a parallel port, serial port, game port, or a universal serial bus. Wireless communication between input devices and interface 238 is possible as well, and includes infrared, BLUETOOTH® wireless technology, WiFi technology (802.11a/b/g/n etc.), cellular, or other radio frequency communication systems in some possible embodiments.

In this example embodiment, a touch sensitive display device 240 is also connected to the system bus 206 via an interface, such as a video adapter 242. The touch sensitive display device 240 includes touch sensors for receiving input from a user when the user touches the display. Such sensors can be capacitive sensors, pressure sensors, or other touch sensors. The sensors not only detect contact with the display, but also the location of the contact and movement of the contact over time. For example, a user can move a finger or stylus across the screen to provide written inputs. The written inputs are evaluated and, in some embodiments, converted into text inputs.

In addition to the display device 240, the computing device 200 can include various other peripheral devices (not shown), such as speakers or a printer.

The computing device 200 further includes a communication device 246 configured to establish communication across the network. In some embodiments, when used in a local area networking environment or a wide area networking environment (such as the Internet), the computing device 200 is typically connected to the network through a network interface, such as a wireless network interface 248. Other possible embodiments use other wired and/or wireless communication devices. For example, some embodiments of the computing device 200 include an Ethernet network interface, or a modem for communicating across the network. In yet other embodiments, the communication device 246 is capable of short-range wireless communication. Short-range wireless communication is one-way or two-way short-range to medium-range wireless communication. Short-range wireless communication can be established according to various technologies and protocols. Examples of short-range wireless communication include a radio frequency identification (RFID), a near field communication (NFC), a Bluetooth technology, and a Wi-Fi technology.

The computing device 200 typically includes at least some form of computer-readable media. Computer readable media includes any available media that can be accessed by the computing device 200. By way of example, computer-readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 200.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

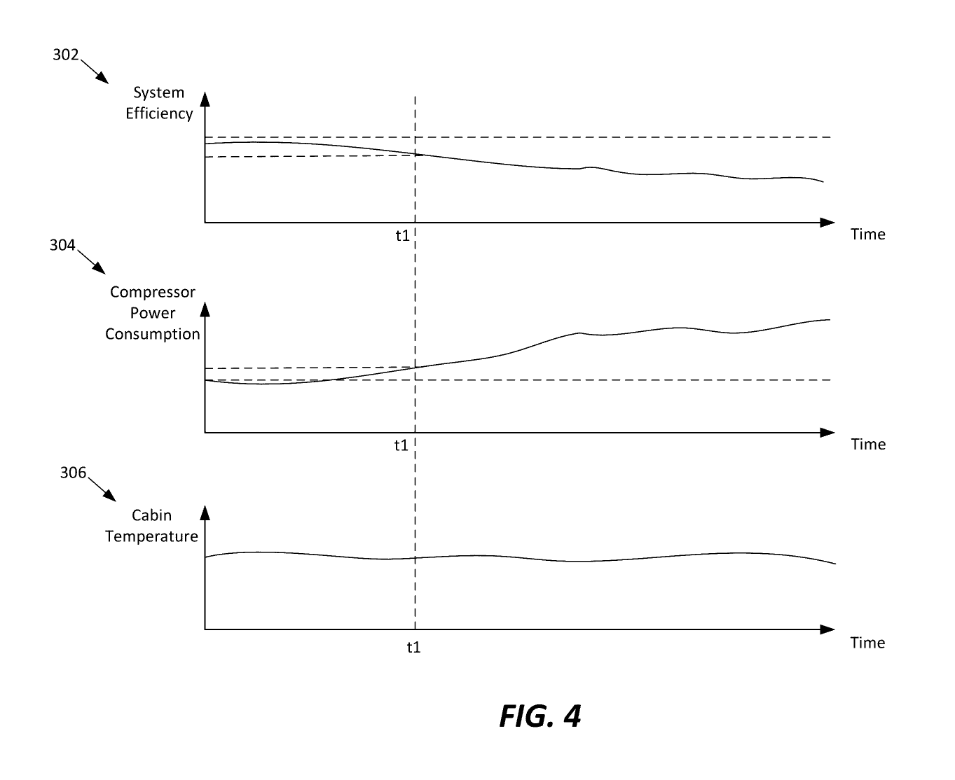

Referring to FIG. 4, an exemplary operational status of the refrigeration system 102 is illustrated. For example, a first graph 302 depicts a change in efficiency of the refrigeration system 102 over time. A second graph 304 illustrates a change in power consumption by the compressor over time. A third graph 306 depicts a change in cabin temperature over time. As illustrated, the system efficiency can decrease over time for various reasons, such as compromised refrigerants, refrigerant leaks, and mechanical problems in the refrigeration system 102. However, some embodiments of the refrigeration system 102 are configured to increase the workload of the compressor and/or other components of the refrigeration system 102 to compensate for the decrease in the system efficiency (as shown in the second graph 304) and maintain the cabin temperature substantially consistent (as shown in the third graph 306). As described herein, the efficiency monitoring system 150 operates to detect the decrease in system efficiency at or before a time (t1) that the refrigeration system increases the workload too much to compensate the decreasing efficiency, and provides a notification before a user notices it or before an alarm is triggered based on measurements by temperature sensors.

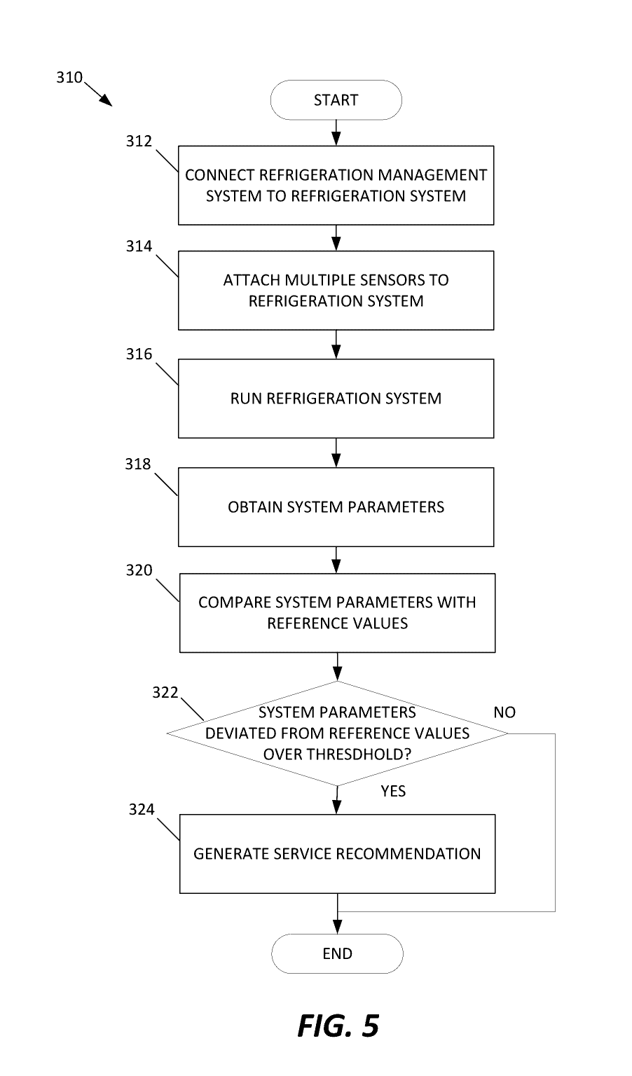

Referring to FIG. 5, a method 310 for operating the efficiency monitoring system 150 is illustrated in accordance with an exemplary embodiment of the present disclosure. In some examples, the method 310 begins at operation 312, in which the refrigeration management system 104 is connected to the refrigeration system 102 for managing the refrigeration system 102.

At operation 314, a plurality of sensor units 170 are attached to the refrigeration system 102. The sensor units 170 are mounted at various locations, such as the high and low pressure sides, refrigerant lines, a cabin (e.g., a space to be air-conditioned by the refrigeration system), an air vent at the cabin, and other locations in the refrigeration system 102 that provide data suitable for monitoring the efficiency change in the refrigeration system 102. In this document, a vent, an air vent, or vent temperature is interchangeably used with a duct, an air duct, or a duct temperature.

At operation 316, the refrigeration system 102 is run for a preset amount of time. In some embodiments, the refrigeration system 102 is operated until the operation is stabilized.

At operation 318, the refrigeration management system 104 (e.g., the efficiency monitoring system 150) is operated to obtain system parameters. The system parameters can be used to identify characteristics of the refrigeration system 102. At least some of the system parameters can be represented by a plurality of measurements obtained by the sensor units 170. Examples of the system parameters include low side pressure, high side pressure, ambient temperature, cabin temperature, vent temperature (including an initial vent temperature and a vent temperature once the pressures have stabilized), dew point, relative humidity, and refrigerant pressure. In some embodiments, the system parameters include one or more values calculated based on the measured system parameters. Examples of such values include a change in low side pressures, a change in high side pressures, a pressure difference between two pressure values, and a temperature difference between two temperature values such as a high side temperature difference, a low side temperature difference, a first air temperature difference, and a second air temperature difference, as described below. The system parameters can further include parameters that are associated with or relevant to operation of the refrigeration system 102. Examples of the system parameters of such type include soak pressures, such as a high side soak pressure and a low side soak pressure.

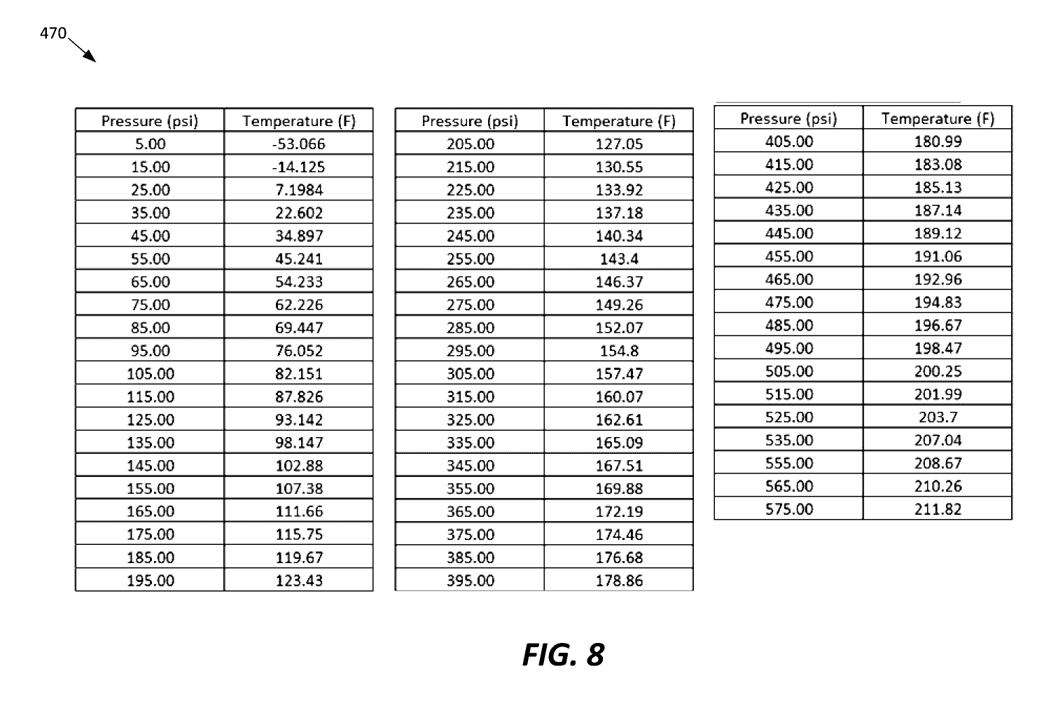

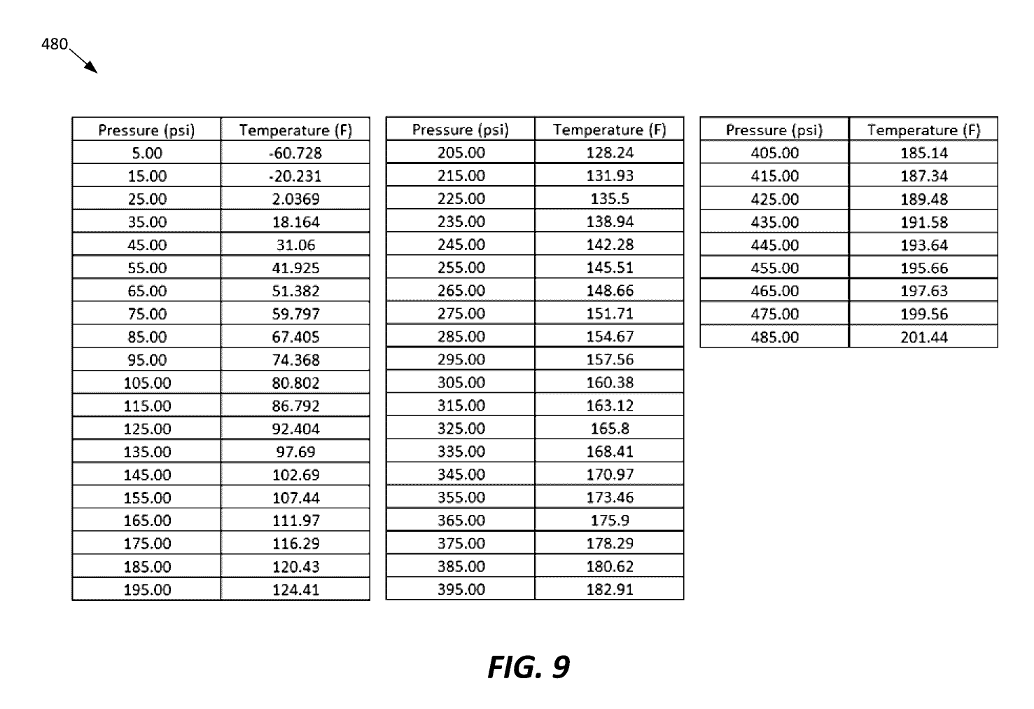

At operation 320, the refrigeration management system 104 (e.g., the efficiency monitoring system 150) operates to compare the system parameters with reference values. Such reference values are representative of a normal operating status or condition of the refrigeration system 102. In some embodiments, the reference values are included in the reference data 180. Some of the reference values include ranges and data points representative of a normal specification of a refrigeration system as defined by a manufacturer of the refrigeration system. Example tables for data points in a normal system operation are illustrated in FIGS. 8 and 9. In some embodiments, the reference values vary depending on the type of refrigerant used in the refrigeration system 102. By way of example, the table 470 in FIG. 8 shows data points of the pressure and temperature of R134a refrigerant in a normal operating condition, and the table 480 in FIG. 9 shows data points of the pressure and temperature of R1234yf refrigerant in a normal operation condition.

At operation 322, the refrigeration management system 104 (e.g., the efficiency monitoring system 150) determines whether the system parameters are deviated from the reference values over one or more predetermined threshold. If it is determined that the system parameters are not shifted from the reference values over the thresholds (“NO” at the operation 322), the method 310 ends.

If it is determined that the system parameters are shifted from the reference values over the thresholds (“YES” at the operation 322), the method 310 goes on to operation 324, in which the refrigeration management system 104 (e.g., the efficiency monitoring system 150) generates a service recommendation. The service recommendation includes information indicating that maintenance is required or desirable to improve the efficiency of the refrigeration system 102.

In accordance with an exemplary embodiment of the method 310 above, some embodiments of the refrigeration management system 104 (e.g., the efficiency monitoring system 150) operate to obtain the pressure changes of the high side cooling line of a refrigerant in the refrigeration system 102, and determine the degree of transition from a normal state based on a combination of some or all of the system parameters including ambient temperature, cabin temperature, initial vent temperature (i.e., an air vent temperature before or shortly after running the refrigeration system), temperature after the pressure has stabilized (i.e., an air vent temperature when the high and low side pressures has stabilized), dew point, and refrigerant pressures.

In other embodiments, the refrigeration management system 104 (e.g., the efficiency monitoring system 150) operate to obtain the pressure changes of the low side cooling line of the refrigerant in the refrigeration system 102, and determine the degree of transition from a normal state based on a combination of some or all of the system parameters including ambient temperature, cabin temperature, initial vent temperature, temperature after the pressure has stabilized, dew point, and refrigerant pressures.

In yet other embodiments, the refrigeration management system 104 (e.g., the efficiency monitoring system 150) operate to obtain the pressure changes of both the high and low side cooling lines of the refrigerant in the refrigeration system 102, and determine the degree of transition from a normal state based on a combination of some or all of the system parameters including ambient temperature, cabin temperature, initial vent temperature, temperature after the pressure has stabilized, dew point, and refrigerant pressures.

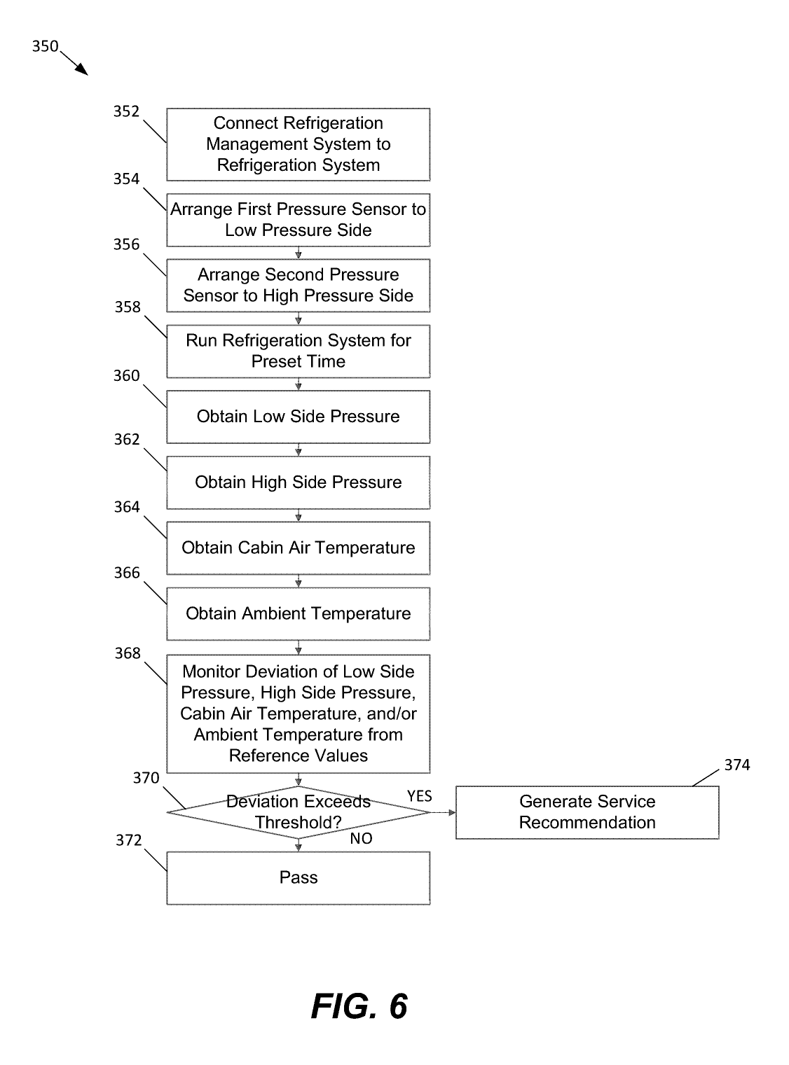

Referring to FIG. 6, a method 350 for operating the efficiency monitoring system 150 is illustrated in accordance with another exemplary embodiment of the present disclosure. In some examples, the method 350 begins at operation 352, in which the refrigeration management system 104 is connected to the refrigeration system 102 for managing the refrigeration system 102. At operation 354, a first pressure sensor is arranged at the low pressure side, such as the low pressure tubing 122. At operation 356, a second pressure sensor is arranged at the high pressure side, such as the high pressure tubing 120. At operation 358, the refrigeration system 102 is run for a preset amount of time. In some embodiments, the refrigeration system 102 is operated until the operation is stabilized.

At operation 360, the efficiency monitoring system 150 operates to obtain a low side pressure through the first pressure sensor. At operation 362, the efficiency monitoring system 150 operates to obtain a high side pressure through the second pressure sensor. At operation 364, the efficiency monitoring system 150 can further obtain air temperature in a cabin that is to be conditioned by the refrigeration system 102. At operation 366, the efficiency monitoring system 150 can also obtain ambient temperature around the refrigeration system 102, such as a temperature outside a vehicle or the cabin thereof in which the refrigeration system 102 is employed.

At operation 368, the efficiency monitoring system 150 monitors a deviation of at least one of the low side pressure, the high side pressure, the cabin air temperature, and the ambient temperature from one or more reference values. As described with reference to FIG. 5, the reference values are representative of a normal operating status of the refrigeration system 102.

At operation 370, the efficiency monitoring system 150 determines whether the deviation exceeds a predetermined threshold. If it is determined that the deviation is not over the threshold (“NO” at the operation 370), it is considered that the refrigeration system 102 maintains the efficiency at a desirable level, and the method 350 ends at operation 372.

If it is determined that the deviation exceeds the threshold (“YES” at the operation 370), the method 350 continues at operation 374, in which the efficiency monitoring system 150 generates a service recommendation. The service recommendation includes information indicating that maintenance is required or desirable to improve the efficiency of the refrigeration system 102.

In other embodiments, the method 350 includes only some of the operations described in FIG. 6. In yet other embodiments, the method 350 includes other operations, in addition to some or all of the operations described in FIG. 6.

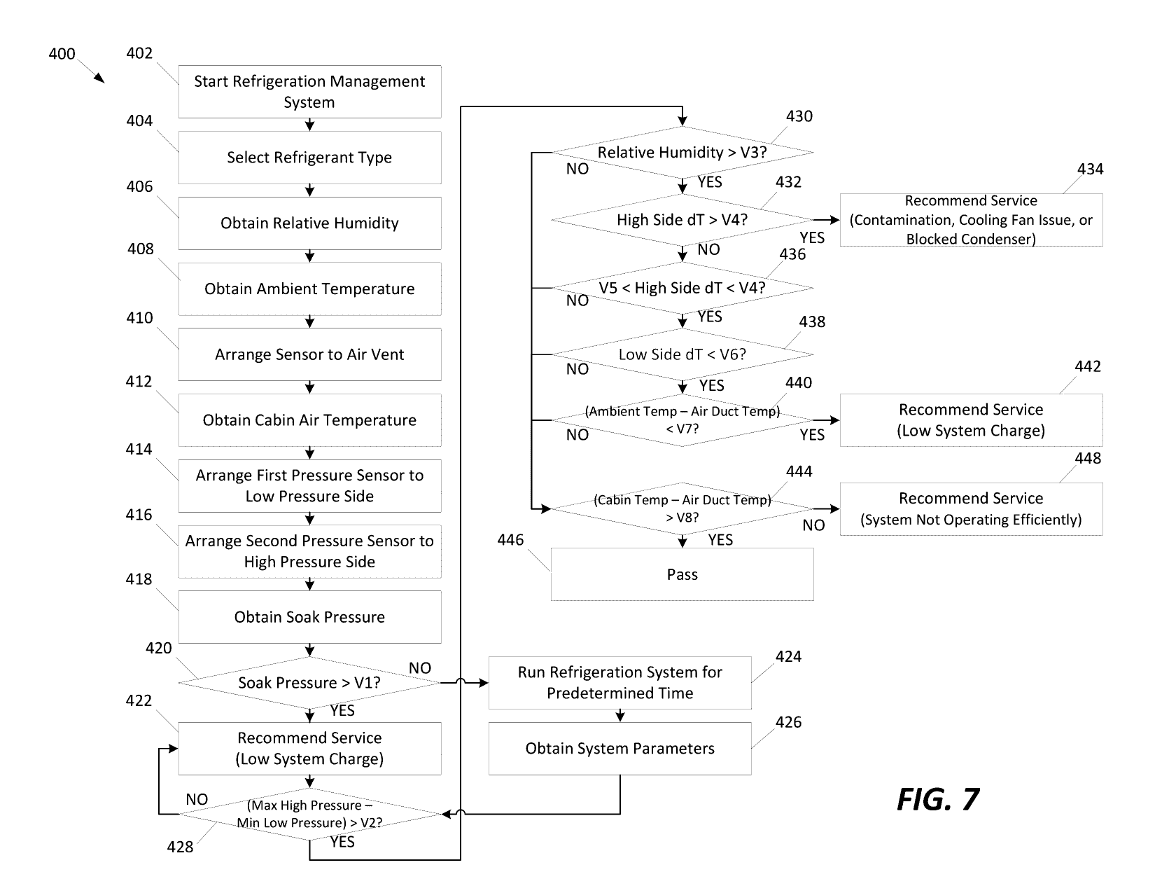

Referring to FIG. 7, a method 400 for operating the efficiency monitoring system 150 is illustrated in accordance with yet another exemplary embodiment of the present disclosure.

At operation 402, the refrigeration management system 104 is started. In this operation, the refrigeration management system 104 is connected to the refrigeration system 102, and the sensor device 154 is mounted to desired locations in the refrigeration system 102. Then, the refrigeration system 102 and the refrigeration management system 104 are powered up and paired so that the refrigeration management system 104 manages and monitors the refrigeration system 102.

In some embodiments, the refrigeration management system 104 can run a checkup program for the refrigeration system 102. The refrigeration management system 104 can further perform a refrigerant initiate test.

At operation 404, the refrigeration management system 104 operates to enable a user to select the type of refrigerant used in the refrigeration system 102. In some embodiments, the refrigeration management system 104 enables a user to input the refrigerant type through the user interface 160 (FIG. 2). In other embodiments, the refrigeration management system 104 automatically detects the type of refrigerant in the refrigeration system 102.

At operation 406, the refrigeration management system 104 operates to obtain relative humidity. In some embodiments, the refrigeration management system 104 enables the user to input the level of relative humidity via the user interface 160. In other embodiments, the refrigeration management system 104 uses at least one of the sensor units 170 to obtain the relative humidity.

In the illustrated example, the level of relative humidity is categorized into two classifications, such as “High” or “Normal.” In other embodiments, the relative humidity can be grouped into different classifications. In yet other embodiments, the relative humidity level can be identified numerically or in numerical ranges.

At operation 408, the refrigeration management system 104 operates to obtain ambient temperature. In some embodiments, the refrigeration management system 104 enables the user to input the ambient temperature via the user interface 160. In other embodiments, the refrigeration management system 104 uses at least one of the sensor units 170 to obtain the ambient temperature.

At operation 410, at least one of the sensor units 170 usable for detecting air temperature is arranged at an air vent (such as an air duct in a vehicle cabin) to obtain a temperature of air flowing out from the air vent. In some embodiments, the air vent temperature sensor units 170 are clipped to the air vent using the associated clamping devices 172.

At operation 412, the refrigeration management system 104 operates to obtain air temperature at a cabin (such as a vehicle cabin) that is air-controlled by the refrigeration system 102. In some embodiments, the air vent temperature sensor units 170 mounted to the air vent at the operation 410 can be used to measure the cabin air temperature. In other embodiments, one or more other sensor units 170 can be used to detect the cabin air temperature. In yet other embodiments, the refrigeration management system 104 enables the user to manually input the cabin air temperature through the user interface 160.

At operation 414, a first pressure sensor (also referred to herein as a low side pressure transducer), which can be one of the sensor units 170, is arranged at the low pressure side of the refrigeration system 102. In some embodiments, the first pressure sensor is mounted to the low pressure tubing 122 using the associated clamping devices 172. The first pressure sensor detects a low side pressure in the refrigeration system 102.

At operation 416, a second pressure sensor (also referred to herein as a high side pressure transducer), which can be one of the sensor units 170, is arranged at the high pressure side of the refrigeration system 102. In some embodiments, the second pressure sensor is mounted to the high pressure tubing 120 using the associated clamping devices 172. The second pressure sensor detects a high side pressure in the refrigeration system 102.

At operation 418, the refrigeration management system 104 obtains a soak pressure. In the illustrated example, the refrigeration management system 104 obtains a soak pressure on the high pressure side (also referred to herein as a high side soak pressure), and a soak pressure on the low pressure side (also referred to herein as a low side soak pressure). The soak pressures can be obtained using the first and second pressure sensors mounted to the refrigeration system 102. In other embodiments, one or more other sensor units 170 can be used to obtain the soak pressures. In yet other embodiments, the refrigeration management system 104 enables the user to manually input the soak pressures through the user interface 160.

At operation 420, the refrigeration management system 104 determines whether the soak pressure exceeds a predetermined value or threshold V1. In the illustrated example, the soak pressure that is used in the operation is calculated as the average of the soak pressure associated with the high pressure side and the soak pressure associated with the low pressure side. Further, in the illustrated example, the predetermined value V1 is set around 40. Therefore, if the average of the soak pressures on the high and low pressure sides is greater than 40 (“YES” at the operation 420), the method 400 moves on to operation 422. Otherwise (“NO” at the operation 420), the method 400 continues on at operation 424. In other embodiments, the soak pressure and the value V1 are determined differently from the above example.

At operation 422, the refrigeration management system 104 generates a service recommendation. The service recommendation can include information indicating possible low system charge. In some embodiments, the refrigeration management system 104 generates a notification representative of the service recommendation through the user interface 160. In other embodiments, the service recommendation is included in a report outputted from the printing device 168 (FIG. 2).

At operation 424, the refrigeration system 102 is run for a predetermined time. In some embodiments, the refrigeration system 102 remains in operation for about 5 minutes. Other durations of keeping the refrigeration system 102 in operation can also be possible.

In the illustrated example where the refrigeration system 102 is implemented in a vehicle, the refrigeration system 102 can be set to operate to the coldest level. In some embodiments, the temperature control of the vehicle is adjusted to the lowest temperature. In other embodiments, the temperature control of the vehicle is adjusted to the automatic setting, which can provide a temperature adjustment of around 72° F.

In addition, a dashboard air fan control of the vehicle is adjusted to the second selection from the fastest setting, or to the fastest selection if there are only two speed selections available.

In some embodiments, at least one (e.g., the driver side window) of the cabin windows of the vehicle can be open while the refrigeration system 102 is running.

At operation 426, the refrigeration management system 104 obtains system parameters. Examples of the system parameters include low side pressure, high side pressure, maximum high side pressure, minimum low side pressure, air vent temperature, minimum air vent temperature, and other parameters suitable for efficiency monitoring process herein. In some embodiments, while the refrigeration system 102 is running, the system parameters are monitored for a predetermined period of time. In the illustrated example, the system parameters are monitored for about 3 minutes after the refrigeration system 102 has run about 5 minutes.

At operation 428, the refrigeration management system 104 determines whether a difference between the maximum high pressure and the minimum low pressure exceeds a predetermined value or threshold V2. In the illustrated example, the predetermined value V2 is set to about 60. In other embodiments, other values are also possible for the predetermined value. If it is determined that the difference is greater than the predetermined value V2 (“YES” at the operation 428), the method 400 continues at operation 430. Otherwise (“NO” at the operation 428), the method 400 returns to the operation 422.

At operation 430, the refrigeration management system 104 determines whether the relative humidity exceeds a predetermined value or threshold V3. In the illustrated example where the relative humidity is classified to either High or Normal, the refrigeration management system 104 determines whether the relative humidity falls into either High or Normal. If it is determined that the relative humidity is High (“YES” at the operation 430), the method 400 continues at operations 432. If it is determined that the relative humidity is not High (“NO” at the operation 430), the method 400 moves on to operation 444. In other embodiments, a numerical value is used as the predetermined value V5.

At operation 432, the refrigeration management system 104 determines whether a high side temperature difference (High Side dT) exceeds a predetermined value or threshold V4. In the illustrated example, the high side temperature difference is defined as a difference between a temperature at the maximum high side pressure and the ambient temperature (i.e., High Side dT=the temperature at the high side pressure−the ambient temperature). In some embodiments, the temperature at the high side pressure is obtained from a data table that shows the relationship between refrigerant temperature and pressure, such as shown in FIGS. 8 and 9. In this example, the predetermined value V4 is set to 85. Accordingly, if it is determined that the high side temperature difference is greater than 85 (“YES” at this operation), the method 400 moves on to operation 434. If not (“NO” at this operation), the method 400 continues at operation 436.

At operation 434, the refrigeration management system 104 generates a service recommendation. The service recommendation can include information indicating possible contamination, cooling fan issue, and/or blocked condenser. In some embodiments, the refrigeration management system 104 generates a notification representative of the service recommendation through the user interface 160. In other embodiments, the service recommendation is included in a report outputted from the printing device 168 (FIG. 2).

At operation 436, the refrigeration management system 104 determines whether the high side temperature difference (High Side dT) is smaller than the predetermined value V4 but greater than a predetermined value or threshold V5. In the illustrated example, the predetermined value V5 is set to 65. Therefore, if it is determined that the high side temperature difference is greater than 65 (but smaller than 85) (“YES” at this operation), the method 400 moves on to operation 438. If not (“NO” at this operation), the method 400 continues at operation 444.

At operation 438, the refrigeration management system 104 determines whether a low side temperature difference (Low Side dT) is smaller than a predetermined value or threshold V6. In the illustrated example, the low side temperature difference is defined as a difference between the cabin air temperature and a temperature at the minimum low side pressure (i.e., Low Side dT=the cabin air temperature−the temperature at the low side pressure). In some embodiments, the temperature at the low side pressure is obtained from a data table that shows the relationship between refrigerant temperature and pressure, such as shown in FIGS. 8 and 9. In this example, the predetermined value V6 is set to 20. Accordingly, if it is determined that the low side temperature difference is smaller than 20 (“YES” at this operation), the method 400 moves on to operation 440. If not (“NO” at this operation), the method 400 continues at operation 444.

At operation 440, the refrigeration management system 104 determines whether a difference between the ambient temperature and the air duct temperature is smaller than a predetermined value or threshold V7. Such a difference is also referred to herein as a first air temperature difference. In the illustrated example, the predetermined value V7 is set to 20. Accordingly, if it is determined that the difference is smaller than 20 (“YES” at this operation), the method 400 moves on to operation 442. If not (“NO” at this operation), the method 400 continues at operation 444.

At operation 442, the refrigeration management system 104 generates a service recommendation. The service recommendation can include information indicating possible low system charge. In some embodiments, the refrigeration management system 104 generates a notification representative of the service recommendation through the user interface 160. In other embodiments, the service recommendation is included in a report outputted from the printing device 168 (FIG. 2).

At operation 444, the refrigeration management system 104 determines whether a difference between the cabin temperature and the air duct temperature is greater than a predetermined value or threshold V8. Such a difference is also referred to herein as a second air temperature difference. In the illustrated example, the predetermined value V8 is set to 35. Accordingly, if it is determined that the difference is greater than 35 (“YES” at this operation), the method 400 moves on to operation 446, in which it is considered that the refrigeration system 102 maintains the efficiency at a desirable level, and the method 400 ends. If it is not determined that the difference is greater than 35 (“NO” at this operation), the method 400 continues at operation 448.

At operation 448, the refrigeration management system 104 generates a service recommendation. The service recommendation can include information indicating that the refrigeration system 102 is either operating efficiently or not operating efficiently (e.g., if efficiency of the refrigeration system 102 drops below a specific threshold, or desirable level). In some embodiments, the refrigeration management system 104 generates a notification representative of the service recommendation through the user interface 160. In other embodiments, the service recommendation is included in a report outputted from the printing device 168 (FIG. 2).

FIG. 10 illustrates an example report 490 that is generated by the refrigeration management system 104 as a result of monitoring efficiency of the refrigeration system 102 as described herein.

In some embodiments, the report 490 includes information 492 about the system parameters that have been detected and calculated as described herein. The report 490 can further include information 494 about the current operating status of the refrigeration system 102 that is determined based on the system parameters, and about service recommendations to return the refrigeration system 102 to its normal operating status, if desirable. Moreover, the report 490 can include information 496 about a predicted result after the maintenance is performed for the refrigeration system 102. For example, the report 490 can present a predicted level of the vent temperature 498 if the refrigeration system 102 is returned to the normal operation status thereof after maintenance or corrective action is taken. In other embodiments, the report 490 can further include information about ranges and data points of the refrigeration system 102 in a normal operation condition as defined by the manufacturer of the refrigeration system 102, as exemplified in FIGS. 8 and 9.

The various examples and teachings described above are provided by way of illustration only and should not be construed to limit the scope of the present disclosure. Those skilled in the art will readily recognize various modifications and changes that may be made without following the example examples and applications illustrated and described herein, and without departing from the true spirit and scope of the present disclosure.

What is claimed is:

1. A method of maintaining a refrigeration system, the refrigeration system configured to control a temperature within a cabin, the method comprising:
arranging a first pressure sensor at a low pressure side of the refrigeration system;
arranging a second pressure sensor at a high pressure side of the refrigeration system;
running the refrigeration system for a preset period of time;
obtaining a low side pressure at the low pressure side using the first pressure sensor;
obtaining a high side pressure at the high pressure side using the second pressure sensor;
obtaining a cabin air temperature using at least one temperature sensor;
obtaining ambient temperature around the refrigeration system;
determining a status of the refrigeration system by monitoring a deviation of at least one of the low side pressure, the high side pressure, the cabin air temperature, and the ambient temperature from at least one reference value, the at least one reference value representative of a normal operational status of the refrigeration system; and
generating a service recommendation based on the status of the refrigeration system.

2. The method of claim 1, wherein a single pressure sensing device is provided for both the first pressure sensor and the second pressure sensor.

3. The method of claim 1, wherein the at least one reference value includes one or more values representative of at least one of an ambient temperature, a cabin temperature, an air vent temperature, a low side pressure, a high side pressure, dew point, and relative humidity of the refrigeration system in a normal operation.

4. The method of claim 3, further comprising:
obtaining an air vent temperature using the at least one temperature sensor;
obtaining relative humidity within the cabin;
wherein determining a status of the refrigeration system includes monitoring a deviation of at least one of the air vent temperature and the relative humidity from the at least one reference value.

5. The method of claim 4, wherein obtaining the air vent temperature includes:
detecting a first air vent temperature shortly after running the refrigeration system; and
detecting a second air vent temperature when the low side pressure and the high side pressure have stabilized.

6. The method of claim 1, further comprising:
obtaining an air vent temperature using the at least one temperature sensor;
obtaining a maximum high side pressure at the high pressure side using the first pressure sensor;
calculating a high side temperature difference, the high side temperature difference being a temperature corresponding to the maximum high side pressure less the ambient temperature;
wherein determining the status of the refrigeration system includes:
comparing the high side temperature difference with a first threshold; and
determining that the status of the refrigeration system deviates from the normal operational status if the high side temperature difference is greater than the first threshold.

7. The method of claim 1, further comprising:
obtaining an air vent temperature using the at least one temperature sensor;
obtaining a minimum low side pressure at the low pressure side using the second pressure sensor; and
calculating a low side temperature difference, the low side temperature difference being the cabin air temperature less a temperature corresponding to the minimum low side pressure;
wherein determining the status of the refrigeration system includes:
comparing the low side temperature difference with a second threshold; and
determining that the status of the refrigeration system deviates from the normal operational status if the low side temperature difference is less than the second threshold.

8. The method of claim 6, further comprising:
obtaining an air vent temperature using the at least one temperature sensor;
obtaining a minimum low side pressure at the low pressure side using the second pressure sensor; and
calculating a low side temperature difference, the low side temperature difference being the cabin air temperature less a temperature corresponding to the minimum low side pressure;
wherein determining the status of the refrigeration system includes:
comparing the low side temperature difference with a second threshold; and
determining that the status of the refrigeration system deviates from the normal operational status if the low side temperature difference is less than the second threshold.

9. The method of claim 8, further comprising:
calculating a first air temperature difference, the first air temperature difference being the ambient temperature less the air vent temperature;
wherein determining the status of the refrigeration system includes:
comparing the first air temperature difference with a third threshold; and
determining that the status of the refrigeration system deviates from the normal operational status if the first air temperature difference is less than the third threshold.

10. The method of claim 9, further comprising:
calculating a second air temperature difference, the second air temperature difference being the second air cabin temperature less the second air vent temperature;
wherein determining the status of the refrigeration system includes:
comparing the second air temperature difference with a fourth threshold; and
determining that the status of the refrigeration system deviates from the normal operational status if the second air temperature difference is less than the forth threshold.

11. The method of claim 1, wherein generating the service recommendation includes generating a notification that recommends a service of the refrigeration system if the deviation is greater than a predetermined amount.

12. The method of claim 1, further comprising:
arranging a temperature sensor at the cabin to measure the cabin air temperature;
moving the temperature sensor adjacent an air vent in the cabin to measure the air vent temperature; and
moving the temperature sensor outside the cabin to measure the ambient temperature.

13. A system for monitoring a refrigeration system for controlling a temperature within a cabin, the refrigeration system including a low pressure conduit defining a low pressure side of the refrigeration system, and a high pressure conduit defining a high pressure side of the refrigeration system, the monitoring system comprising:
at least one sensing device configured to detect a plurality of characteristics of the refrigeration system, the plurality of characteristics including at least one of ambient temperature, cabin air temperature, high side pressure, and low side pressure; and
a monitoring device connected to the at least one sensing device, the monitoring device configured to receive a plurality of measurements representative of the plurality of characteristics from the at least one sensing device, determine a deviation of at least one of the plurality of measurements from at least one reference value, and output a status of the refrigeration system based on the deviation, the at least one reference value representative of a normal operational status of the refrigeration system.

14. The system of claim 13, wherein the at least one reference value includes one or more values representative of at least one of an ambient temperature, a cabin temperature, an air vent temperature, a low side pressure, a high side pressure, dew point, and relative humidity of the refrigeration system in a normal operation.

15. The system of claim 14, wherein the monitoring device is configured to receive an air vent temperature from the at least one sensing device, obtain relative humidity within the cabin, and monitor a deviation of at least one of the air vent temperature and the relative humidity from the at least one reference value.

16. The system of claim 13, wherein the monitoring device is configured to:
receive an air vent temperature;
obtain a maximum high side pressure at the high pressure side;
calculate a high side temperature difference, the high side temperature difference being a temperature corresponding to the maximum high side pressure less the ambient temperature
compare the high side temperature difference with a first threshold; and
determine that the status of the refrigeration system deviates from the normal operational status if the high side temperature difference is greater than the first threshold.

17. The system of claim 16, wherein the monitoring device is configured to:
obtain a minimum low side pressure at the low pressure side;
calculate a low side temperature difference, the low side temperature difference being the cabin air temperature less a temperature corresponding to the minimum low side pressure;
compare the low side temperature difference with a second threshold; and
determine that the status of the refrigeration system deviates from the normal operational status if the low side temperature difference is less than the second threshold.

18. The system of claim 17, wherein the monitoring device is configured to:
calculate a first air temperature difference, the first air temperature difference being the ambient temperature less the air vent temperature;
compare the first air temperature difference with a third threshold; and
determine that the status of the refrigeration system deviates from the normal operational status if the first air temperature difference is less than the third threshold.

19. The system of claim 18, wherein the monitoring device is configured to:
calculate a second air temperature difference, the second air temperature difference being the second air cabin temperature less the second air vent temperature;
compare the second air temperature difference with a fourth threshold; and
determine that the status of the refrigeration system deviates from the normal operational status if the second air temperature difference is less than the forth threshold.

20. The system of claim 13, wherein the monitoring device is configured to provide a notification that recommends a service of the refrigeration system if the deviation is greater than a predetermined amount.

21. The system of claim 13, wherein the refrigeration system is configured as an automotive refrigeration system.

22. A method of maintaining a refrigeration system for controlling a temperature within a cabin, the method comprising:
arranging a first pressure sensor at a low pressure side of the refrigeration system;
arranging a second pressure sensor at a high pressure side of the refrigeration system;
receiving relative humidity;
receiving ambient temperature around the refrigeration system;
obtaining a first low side pressure at the low pressure side and a first high side pressure at the high pressure side using the at least one pressure sensor;
determining a soak pressure based on the low pressure and the high pressure;
if the soak pressure is greater than a first predetermine value, outputting a notification that recommends a service of the refrigeration system;
if the soak pressure is not greater than the first predetermined value,
running the refrigeration system for a preset period of time;
obtaining a minimum low side pressure at the low pressure side using the first pressure sensor;
obtaining a maximum high side pressure at the high pressure side using the second pressure sensor;
obtaining a cabin air temperature using at least one temperature sensor;
obtaining an air vent temperature using the at least one temperature sensor; and
determining a difference between the maximum high side pressure and the minimum low side pressure;
determining that the difference between the maximum high side pressure and the minimum low side pressure is greater than a second predetermined value;
if the difference between the maximum high pressure and the minimum low pressure is greater than a second predetermined value,
calculating a high side temperature difference, the high side temperature difference being a temperature corresponding to the maximum high side pressure less the ambient temperature;
calculating a low side temperature difference, the low side temperature difference being the cabin air temperature less a temperature corresponding to the minimum low side pressure;
calculating a first air temperature difference, the first air temperature difference being the ambient temperature less the air vent temperature;
calculating a second air temperature difference, the second air temperature difference being the cabin air temperature less the air vent temperature;
monitoring a deviation of at least one of the high side temperature difference, the low side temperature difference, the first air temperature difference, and the second air temperature difference from at least one reference value, the at least one reference value representative of a normal operational status of the refrigeration system; and
determining a status of the refrigeration system based on the deviation.
